(19) United States
(12) Patent Application Publication
(10) Pub. No.: US 2026/0204126 A1
(43) Pub. Date: Jul. 16, 2026

(54) CARD GAME APPARATUS, COMPUTER PROGRAM, AND COMPUTER-READABLE RECORDING MEDIUM HAVING COMPUTER PROGRAM RECORDED THEREIN

(71) Applicant: SEGA SAMMY CREATION INC., Tokyo (JP)

(72) Inventors: Hiroyuki MIYANO, Tokyo (JP); Hideki MURATA, Tokyo (JP); Takeshi SHIMA, Tokyo (JP)

(21) Appl. No.: 19/561,516

(22) Filed: Mar. 10, 2026

Related U.S. Application Data
(63) Continuation of application No. PCT/JP2024/044961, filed on Dec. 19, 2024.

(51) Int. Cl. G07F 17/32

(52) U.S. Cl. CPC G07F 17/3213; G07F 17/3293

(57) ABSTRACT

An apparatus for a card game in which a card with a design on a front surface indicating a card type is dealt face down and, when turning the dealt card face up, the user perform a squeezing motion of turning from an end of the card, includes a storage device and a CPU which executes displaying the card dealt to the user face down on a display screen on which a state at a side of the user is simulated, receiving a rotation instruction for the card to a predetermined input region on the display screen, rotating the card by changing an orientation of the card in steps, and displaying an icon promoting input of the rotation instruction and having a predetermined shape while rotating the icon to match a current orientation of the card.

### CROSS-REFERENCE TO RELATED APPLICATIONS

The present application is a continuation application of International Application number PCT/JP2024/044961, filed on Dec. 19, 2024, content of which is incorporated herein by reference in its entirety.

### FIELD

The present invention relates to a card game apparatus, a computer program, and a computer-readable recording medium having the computer program recorded therein.

### BACKGROUND

In some card games played in casinos, such as baccarat, a card is dealt face down such that the suit and score on the card surface is not seen, and a game participant then turns the card face up to determine the winner based on the suit and score on the surface of his or her card and those on the surface of the card of an opponent.

When turning over the card, the game participant performs a motion of slowly turning it over from an end (squeezing motion) such that the suit and score on the card surface can be gradually seen, while praying that he or she will win. Turning over the card slowly increases the sense of thrill due to the tension and excitement until the winner is determined, which is one of the most exciting parts of card games.

Patent Literature 1 describes a card game apparatus that enables such a card game to be played not with real cards but in simulation on a screen. This card game apparatus is provided with a touch panel as a display screen, and a user can perform the squeezing motion to a displayed card by sliding his or her finger on the touch panel.

### CITATION LIST

### Patent Literature

Patent Literature 1: International Publication No. WO 2016/185548

### SUMMARY

### Technical Problem

Unfortunately, when a game is played with such a card game apparatus, for example, slight discomfort or difficulty in using a user interface, a user error in operation, or the like may cause the user to lose concentration and lose a feeling of excitement over the game.

For example, if operation is difficult or an operation method is difficult to understand when the user is about to perform the squeezing motion in an important phase of winning or losing the game, the feeling of the user may be brought down greatly.

Thus, an object of the present invention is to provide, in a card game apparatus that makes progress of a card game, such as baccarat, a user interface that enables a user to further enjoy the game.

### Solution to Problem

A card game apparatus solving the above problem is a card game apparatus that makes progress of a card game in which a card with a design depicted on a front surface and indicating a card type is dealt face down from a dealer to a user and, when turning the dealt card face up, the user can perform a squeezing motion of turning from an end of the card, and that includes a storage device and a CPU connected to the storage device. The CPU executes displaying the card dealt to the user face down on a user card display screen on which a state at a side of the user is simulated, receiving a rotation instruction for the card through operation input to a predetermined input region disposed on the user card display screen, rotating the card by changing an orientation of the card in steps each time the rotation instruction is received, and displaying an icon promoting input of the rotation instruction and having a predetermined shape in the predetermined input region while rotating the icon to match a current orientation of the card.

Other problems and solutions disclosed in the present application are described in the section of the description of embodiments and the drawings.

### Advantageous Effects of Invention

According to the present invention, in the card game apparatus that makes progress of the card game, a user interface that enables the user to further enjoy the game can be provided.

### BRIEF DESCRIPTION OF DRAWINGS

FIG. 1 is an external perspective view of a card game apparatus according to one embodiment of the present invention.

FIG. 2 is an internal hardware configuration diagram of the card game apparatus according to the present embodiment.

FIG. 3 is a block diagram illustrating a functional configuration of the card game apparatus according to the present embodiment.

FIG. 4 is a diagram illustrating a configuration of display position data.

FIG. 5 is a diagram illustrating a configuration of card image data.

FIG. 6 is a diagram illustrating a configuration of card shape data.

FIG. 7 is a diagram illustrating a configuration of bet data.

FIG. 8 is a diagram illustrating a configuration of distributed card data.

FIG. 9 is a diagram illustrating a configuration of card rotation icon data.

FIG. 10 is a diagram illustrating a configuration of squeezing motion promotion icon data.

FIG. 11 is a diagram illustrating a configuration of rotation orientation setting data.

FIG. 12 is a general flow diagram illustrating an overview of a flow of processing executed from the start until the end of one baccarat game in the card game apparatus according to the present embodiment.

FIG. 13 is a diagram illustrating a state where cards are moved from a banker region of a dealer display device to a user display device and are displayed.

FIGS. 14A and 14B are diagrams illustrating a state where a card displayed on the user display device is rotated on an instruction from a user.

FIG. 15 is a diagram illustrating a state where a squeezing motion promotion icon is displayed.

FIG. 16 is a flow diagram of processing executed by a CPU in user distributed card display processing.

FIG. 17 is a flowchart of processing executed by the CPU in card squeezing processing.

FIGS. 18A and 18B are diagrams for describing how front surfaces are seen when diagonal squeezing is performed to cards from lower corners.

### DESCRIPTION OF EMBODIMENTS

Embodiments according to the present invention are described below in detail. The embodiments and modifications below are examples to explain the present invention, and the present invention is not limited only to the embodiments. The present invention can be modified in various ways as long as it does not depart from the gist of the invention. Furthermore, a person skilled in the art can adopt embodiments in which the elements described below are replaced by equivalent ones, and such embodiments are also included in the scope of the invention.

First, the terms used in the present application are explained.

“Baccarat” means a card game exemplified in the present embodiment, in which a user bets on the winner of the card game between a banker (bookmaker) and a player (customer). A dealer deals two or three playing cards to the banker and the player according to the rules of the game. One of the banker and the player whose first digit of the total number on the hand is closer to “9” wins.

“Bet” means predicting whether the banker or the player will win and placing a bet in correspondence with this win and loss prediction.

“Suit” means a mark recorded on the front surface of a card. For example, playing cards described in the present embodiment have four types of suits of spades, hearts, diamonds, and clubs.

“Score” means a numerical value represented by the number of suits or a picture displayed on the front surface of a card. The number of suits represents the score A (=1) or 2 to 10, and the type of the picture represents the score “J” (=11), “Q” (=12), or “K” (=13).

“Card type” means a combination of “suit” and “score” in the present specification because the card type of a card is identified by “suit” and “score” displayed on the card front surface, like “the ace of spades” and “the seven of hearts”.

“Squeezing motion” means a motion of turning over an end of a card lying face down such that the back surface can be seen while bending the card with the number at the end of the card hidden (in a real game, with the user hiding the number with his or her finger, in the present embodiment, by generating an image such that the number is not displayed) and making part of the score on the front surface visually recognizable. If the card has a rectangular shape, there are three types of squeezing motions: “diagonal squeezing” of turning over the card from a corner; “vertical squeezing” of turning over the card from the short side; and “horizontal squeezing” of turning over the card from the long side.

“Flip-over motion” means a motion of quickly flipping over a card so that the entire score on the front surface of the card can be seen, without performing the squeezing motion. Performing “squeezing motion” part way and then quickly flipping over a card is also referred to as “flip-over motion”.

Concerning “upward/downward orientation” of a card, the use of rectangular playing cards is assumed in the present embodiment, and one orientation defined by the design (arrangement of a displayed suit or picture) on the front surface is regarded as an upward orientation and the orientation rotated 180° in the card plane from the upward orientation as a downward orientation. If the card is seen on the back surface, “upward/downward orientation” cannot be distinguished between the upward orientation and the downward orientation. Note that the upward/downward orientation of the card front surface may also be incapable of being distinguished because some card types are vertically symmetrical; however, even in that case, either orientation is regarded as “upward orientation”.

“Rotation orientation” of a card means an orientation of the card determined by rotation that can be performed to a displayed card diagonally right-up, right-laterally, downward, diagonally left-down, left-laterally, and upward in steps in the card plane in the present embodiment.

### Configuration of Card Game Apparatus

### <<External Configuration of Card Game Apparatus>>

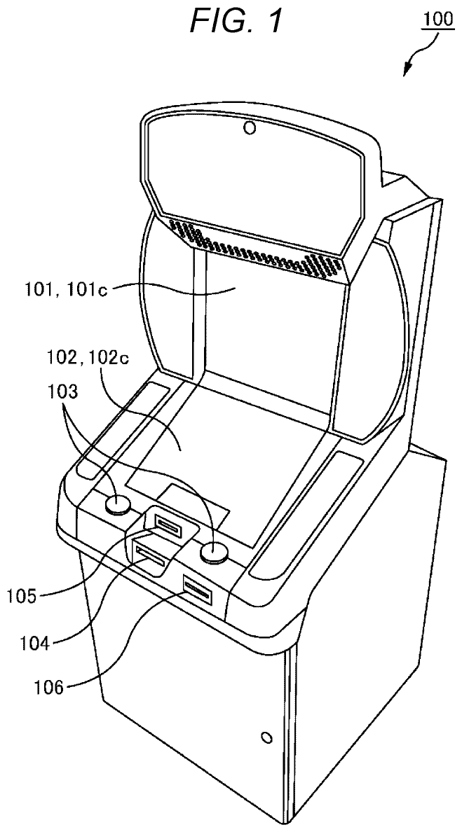

FIG. 1 is an external perspective view of a card game apparatus 100 according to one embodiment of the present invention. The card game apparatus 100 exemplified in FIG. 1 is a game apparatus that is installed in casinos, amusement facilities, or the like and that makes progress of baccarat being an example of the card game. The user can play baccarat with the card game apparatus 100.

As illustrated in FIG. 1, the card game apparatus 100 includes a dealer display device 101 that displays a dealer card display screen 101c on which a state at the dealer's side is simulated, a user display device 102 that displays a user card display screen 102c on which a state at the user's side is simulated, operation buttons 103, a card reading device 104, a banknote insertion device 105, and a ticket dispensing device 106.

The dealer display device 101 is disposed on a back side of the card game apparatus 100 (the upper right side in FIG. 1) while facing a front side (the lower left side in FIG. 1), and the user display device 102 is disposed on the front side while inclining slightly toward the front side from an upward orientation. Note that the user plays the game, sitting on a chair installed in front of the card game apparatus 100 (or standing).

Each of the dealer display device 101 and the user display device 102 is composed of a touch panel, and the user can input an instruction to the card game apparatus 100 by performing operation, such as a touch, a swipe, and a flick, on the screen.

In this way, by separating a display device into the dealer display device 101 and the user display device 102 and installing the user display device 102 on the front side of the card game apparatus 100, the user can perform the squeezing motion and the like, described later, through the touch panel of the user display device 102 while looking at the cards displayed on the user display device 102 at his or her side and can thus enjoy the game with a sense close to baccarat using real cards.

The operation buttons 103 are physical buttons for inputting an instruction from the user to the card game apparatus 100. In the present embodiment, the operation buttons 103 are used to perform the flip-over motion to a card and are installed on both the right and left sides of the user display device 102 to accommodate right-handed and left-handed users.

The card reading device 104 is a card reader reading information from a magnetic card or an IC card owned by the user. The banknote insertion device 105 is a device reading an inserted banknote or ticket. The ticket dispensing device 106 is a device dispensing a ticket or a banknote to the user. These devices 104 to 106 are used for payment of a stake in betting, payment of a dividend when the game is won, and the like and are not related to the progress of the game, and thus detailed description is omitted.

### <<Internal Hardware Configuration of Card Game Apparatus>>

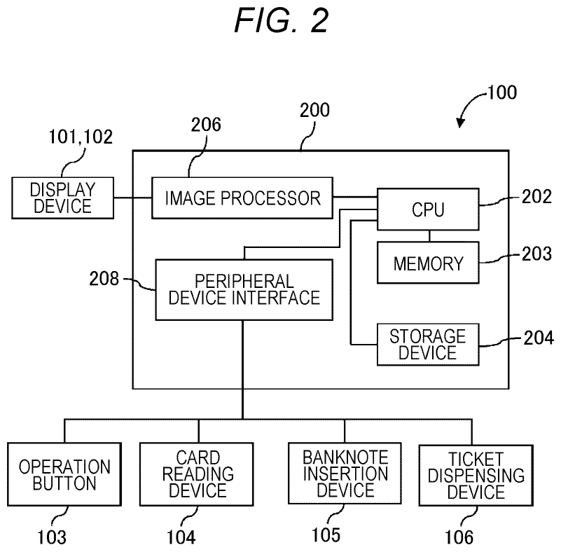

FIG. 2 is an internal hardware configuration diagram of the card game apparatus 100 according to the present embodiment. As illustrated in FIG. 2, the card game apparatus 100 is configured by having, as main hardware, a computer 200 including a CPU 202, a memory 203, a storage device 204, an image processor 206, and a peripheral device interface 208.

The storage device 204 is composed of a computer-readable, non-transitory recording medium, such as ROM, an SSD, and a hard disk. In the storage device 204, a computer program for implementing the function of the card game apparatus 100 and data are recorded, and the CPU 202 writes and reads the data to and from the storage device 204 while executing the computer program recorded in the storage device 204, thereby implementing the function as the card game apparatus 100.

Note that, if the storage device 204 is an SSD or a hard disk, the computer program for performing the function as the card game apparatus 100 may be installed from a portable recording medium, such as a DVD and flash memory, into the storage device 204. Alternatively, the storage device 204 may include a drive device capable of reading data from a DVD or flash memory, and the computer program read from the DVD, flash memory, or the like may be executed.

The image processor 206 generates graphic images (the dealer card display screen 101c and the user card display screen 102c) to be displayed on the dealer display device 101 and the user display device 102 under control of the CPU 202.

The peripheral device interface 208 enables communications between the CPU 202 and peripherals, such as the operation buttons 103, the card reading device 104, the banknote insertion device 105, and the ticket dispensing device 106, and a communication network, such as the Internet.

### <<Functional Configuration of Card Game Apparatus>>

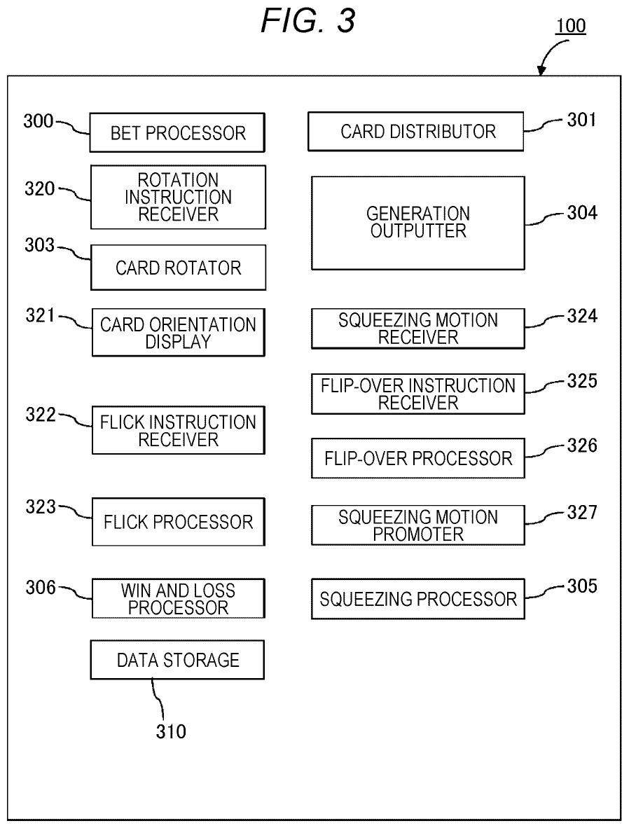

FIG. 3 is a block diagram illustrating a main functional configuration of the card game apparatus 100 according to the present embodiment. As illustrated in FIG. 3, the card game apparatus 100 includes a bet processor 300, a card distributor 301, a card rotator 303, a generation outputter 304, a squeezing processor 305, a win and loss processor 306, a rotation instruction receiver 320, a card orientation display 321, a flick instruction receiver 322, a flick processor 323, a squeezing motion receiver 324, a flip-over instruction receiver 325, a flip-over processor 326, a squeezing motion promoter 327, and a data storage 310.

The bet processor 300 receives a target of a bet (whether the user bets on the player or the banker) and an amount of the bet by the user and stores the bet details in the data storage 310.

The card distributor 301 determines the card types to be dealt to the player and the banker and stores the determined card types in the data storage 310.

The generation outputter 304 displays the cards dealt to the user (the cards of the bet target of the user received by the bet processor 300) face down on the user card display screen 102c of the user display device 102. Similarly, the generation outputter 304 displays the cards dealt to an opponent, on which the user does not bet, face down on the dealer card display screen 101c of the dealer display device 101.

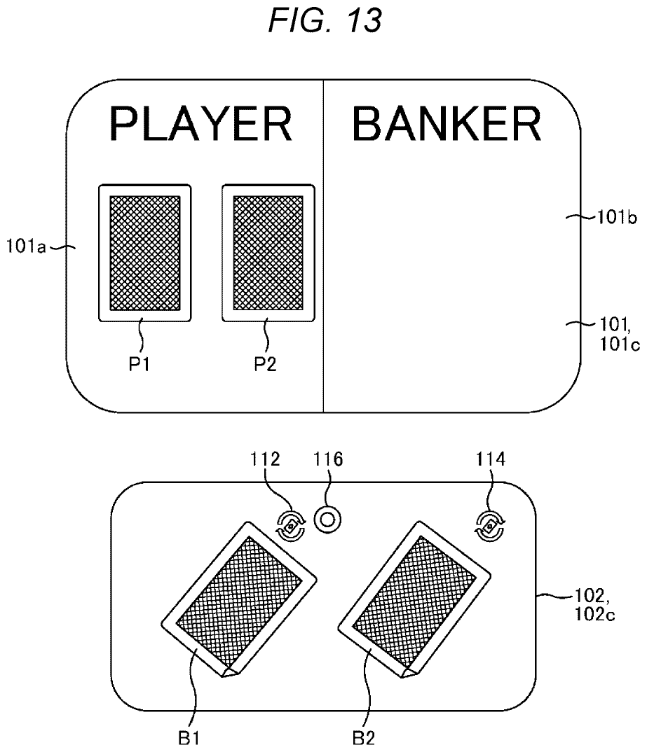

FIG. 13 illustrates a state where the cards dealt to the user and the cards dealt to the opponent are displayed respectively on the user card display screen 102c and the dealer card display screen 101c.

The rotation instruction receiver 320 receives a card rotation instruction through operation input to predetermined input regions disposed on the user card display screen 102c. As illustrated in FIG. 13, the rotation instruction receiver 320 receives the rotation instruction by detecting a touch by the user to portions where card rotation icons 112 and 114 are displayed (the predetermined input regions) on the user card display screen 102c. Note that the rotation instruction receiver 320 receives the rotation instruction for the card displayed on the left side if the card rotation icon 112 is touched and receives the rotation instruction for the card displayed on the right side if the card rotation icon 114 is touched.

The card rotator 303 rotates a card in the card plane in response to the rotation instruction from the user and stores the rotation orientation in the data storage 310. In the present embodiment, the card rotator 303 rotates the card by changing the card orientation in steps each time the rotation instruction is received.

Note that the data storage 310 stores setting information (rotation orientation setting data 318) specifying each card orientation changed in steps and the order of the change, and the card rotator 303 rotates the card by sequentially changing the card orientation to each orientation specified in this setting information each time the rotation instruction is received.

FIG. 11 illustrates the rotation orientation setting data 318. The rotation orientation setting data 318 specifies that the card orientation changes in the order of the diagonal right-up orientation, the right-lateral orientation, the downward orientation, the diagonal left-down orientation, the left-lateral orientation, and specifies the upward orientation, and an angle for each orientation. These angles are specified as angles being clockwise measurements of an orientation from one short side of the card toward the other short side relative to the upward orientation of the user card display screen 102c (an orientation from the front side of the screen toward the back side) as a reference (0°) when a rectangular card is rotated in the plane about the barycentric position (center) of the card as the rotation axis.

Each time the user touches the card rotation icon 112 or 114, the card rotator 303 rotates the card clockwise by changing the orientation from the one short side toward the other short side of the rectangular card displayed on the user card display screen 102c sequentially to the diagonal right-up orientation, the right-lateral orientation, the downward orientation, the diagonal left-down orientation, the left-lateral orientation, and the upward orientation. The card can of course be rotated repeatedly. If the card rotation icon 112 or 114 is touched when the card is in the upward orientation, the card changes to be in the diagonal right-up orientation.

In this way, when the user rotates a card on the screen to perform the squeezing motion, the card orientation is changed in steps, which allows the user to easily determine the card orientation with no stress and to concentrate on enjoying the game. If no limitation is imposed on the card orientation, the user can freely determine the card orientation, which is seemingly better; however, on the contrary, with a too high degree of freedom, the user needs to make fine adjustment of the card angle every time, which may disturb concentration on the game.

Note that the card orientations (especially, the diagonal right-up orientation and the diagonal left-down orientation) in the present embodiment are determined such that, when the user performs the squeezing motion, it is as difficult as possible to identify the card type.

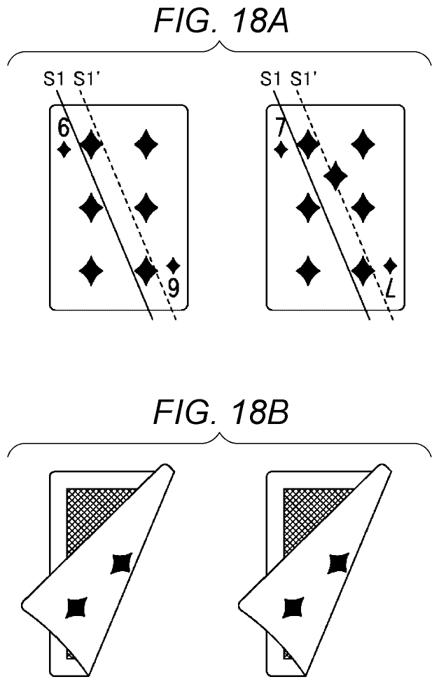

As an example, how the front surfaces are seen when the diagonal squeezing is performed to cards is described with reference to FIGS. 18A and 18B.

FIG. 18A illustrates a state where the entire card front surfaces of the six of diamonds and the seven of diamonds are displayed, and FIG. 18B illustrates a state where, from a state where the back surfaces of these cards are displayed, the diagonal squeezing is performed from corners to the positions of solid lines S1 illustrated in FIG. 18A to reveal part of the designs on the front surfaces.

As illustrated in FIG. 18A, the card with the six of diamonds has such a design that three vertically-aligned diamond marks are displayed in each of two longitudinal rows, and the card with the seven of diamonds has such a design that one diamond mark is further displayed on an upper or lower side in the central row. FIG. 18A illustrates a case where the cards are dealt in such an orientation that the diamond mark in the central row on the seven of diamonds is on the upper side.

With the diagonal squeezing performed as in FIG. 18B, two among the three diamond marks aligned in one of the rows are visible on both the cards with the six and seven of diamonds.

Thus, the diamond mark in the central row is not visible at this stage, so that the user cannot confirm whether the card is the six of diamonds or the seven of diamonds, which can provide the sense of thrill to the user.

When the diagonal squeezing is performed from the corners to the positions of broken lines S1′ illustrated in FIG. 18A, the diamond mark in the central row finally starts to be visible, so that whether it is the six of diamonds or the seven of diamonds can be confirmed.

How these diamond marks are visible changes depending on the card rotation orientation (squeezing direction). If the user can freely determine the rotation orientation, marks on the front surface may be visible too easily depending on the orientation, and the sense of thrill in squeezing may not be gained.

Alternatively, it may occur that handling goes wrong during squeezing and the card is squeezed in an unintended direction, which spoils enjoyment of the sense of thrill in squeezing. Squeezing a card in exactly the same direction every time is also difficult, which increases likelihood that the squeezing motion cannot be performed as the user wishes.

Thus, in the card game apparatus 100 of the present embodiment, the card rotation orientation is preliminarily limited to specific orientations (diagonal right-up orientation, right-lateral orientation, downward orientation, diagonal left-down orientation, left-lateral orientation, and upward orientation) and is set to such an orientation (angle) that, when the user performs the squeezing motion, it is as difficult as possible to identify the card type.

This mode can more reliably provide the sense of thrill in the squeezing motion to the user, allowing the user to further enjoy the game.

The card orientation display 321 displays icons (card rotation icons 112 and 114) promoting input of the rotation instruction and having a predetermined shape while rotating the icons to match current card orientations, in the aforementioned predetermined input regions (the regions disposed to receive the card rotation instruction).

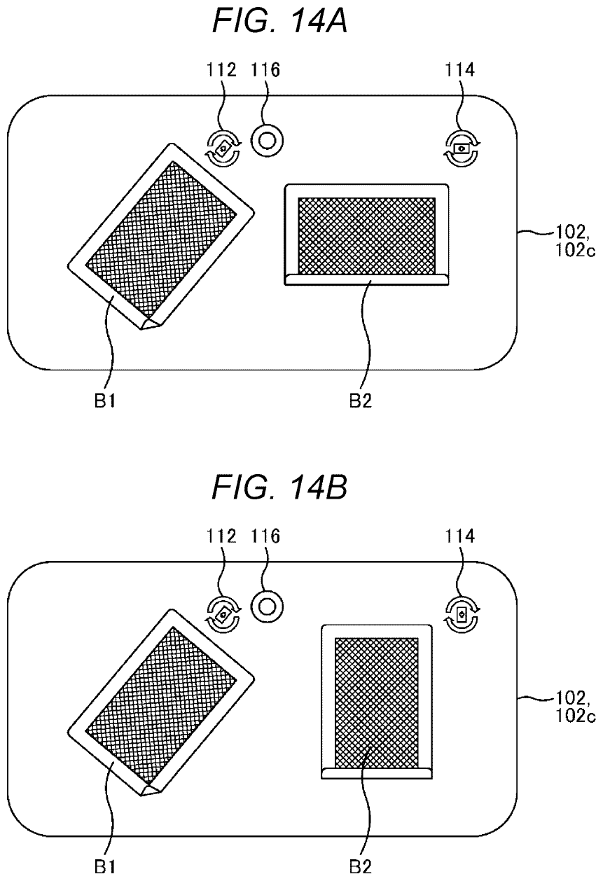

FIGS. 14A and 14b illustrate a state where the orientations of the card rotation icons 112 and 114 change to match current card rotation orientations.

For example, a card B2 displayed on the right side in FIG. 14A is in the right-lateral orientation, and, at this time, the card rotation icon 114 is also displayed in the right-lateral orientation. If the user touches the card rotation icon 114 once in this state, the card B2 rotates in the downward orientation, and the card rotation icon 114 also rotates in the downward orientation accordingly as illustrated in FIG. 14B.

This mode can prevent the user from losing track of the card orientation while rotating the card repeatedly (for example, wondering whether the right or left side is up if the card is displayed laterally), losing concentration, and losing a feeling of enjoying the game. This allows the user to concentrate on enjoying the game with no unnecessary burden when performing the squeezing motion.

The squeezing motion receiver 324 receives the squeezing motion by the user. To be specific, the squeezing motion receiver 324 determines whether the squeezing motion is performed by detecting a touch and a slide on the touch panel composing the user display device 102.

The squeezing processor 305 displays the card displayed face down on the user card display screen 102c in such a manner that the card is turned over gradually in accordance with the squeezing motion.

After the user finishes turning over the two cards dealt to him or her, the generation outputter 304 turns the two cards, displayed face down on the dealer card display screen 101c, of the opponent face up one by one.

The flip-over instruction receiver 325 receives a flip-over instruction to display the card face up without performing the squeezing motion or by interrupting the squeezing motion. The flip-over instruction receiver 325 receives the flip-over instruction by detecting that the user presses either of the right and left operation buttons 103.

The flip-over processor 326 reverses either one of the cards displayed face down so that the card faces up in response to the flip-over instruction. To be specific, if the cards of the opponent are displayed face down on the dealer card display screen 101c, the flip-over processor 326 reverses either one of the cards face up. If no cards of the opponent are displayed face down on the dealer card display screen 101c, either one of the cards displayed face down on the user card display screen 102c is reversed face up.

That is, each time the user presses the operation button 103 once, the flip-over processor 326 reverses the cards face up one by one, giving priority to the cards of the opponent displayed face down on the dealer card display screen 101c.

This mode allows the user to make progress of the game in a short period of time without performing the squeezing motion. That is, immediately after the dealer distributes cards, two cards on the dealer card display screen 101c and two cards on the user card display screen 102c are displayed face down, and, if the user presses the operation button 103 four times in a row in this state, these cards are all turned face up sequentially.

A press on the operation button 103 first turns the cards on the dealer card display screen 101c face up. Thus, the user can also enjoy the game by, for example, pressing the operation button 103 twice, confirming the card types of the two cards on the dealer card display screen 101c, and then performing the squeezing motion to the two cards dealt to the user.

Alternatively, the user can also enjoy the gamy by pressing the operation button 103 once to turn only one of the cards on the dealer card display screen 101c face up, then performing the squeezing motion to either one of the two cards dealt to the user to confirm the card type, pressing the operation button 103 once again to turn the second card on the dealer card display screen 101c face up, and then performing the squeezing motion to the second card dealt to the user to confirm the card type.

In this way, in the card game apparatus 100 of the present embodiment, the cards of the opponent can be turned face up first by pressing the operation button 103 while the cards of the user can be turned face up first if the operation button 103 is not pressed, so that the user can turn the two cards dealt to the user and the two cards dealt to the opponent face up in any order. This can provide various ways of enjoying the squeezing motion to the user.

The flick instruction receiver 322 receives a flick instruction to return a card distributed to the user to the dealer. To be specific, the flick instruction receiver 322 determines whether the flick instruction is given by detecting flick operation to a card displayed on the user card display screen 102c. The card to which the flick operation is performed may be a card displayed face down or a card displayed face up.

In response to this flick instruction, the flick processor 323 moves the card subjected to the flick operation to the dealer card display screen 101c and displays the card face up.

For example, the user performs the flick operation if confirming the card type by performing the squeezing motion to a card distributed to the user and then strongly thinking that he or she does not want to keep this card at hand because the card type is undesirable. Alternatively, if wanting to see the front surface of a card distributed to the user immediately without performing the squeezing motion, the user performs the flick operation to the card that he or she wants to see, whereby that card is moved to the dealer card display screen 101c to allow the user to see the front surface.

The squeezing motion promoter 327 displays information promoting start of the squeezing motion (squeezing motion promotion icon 117) on the user card display screen 102c if the user does not start the squeezing motion after a lapse of a predetermined period of time after the dealer distributes cards to the user.

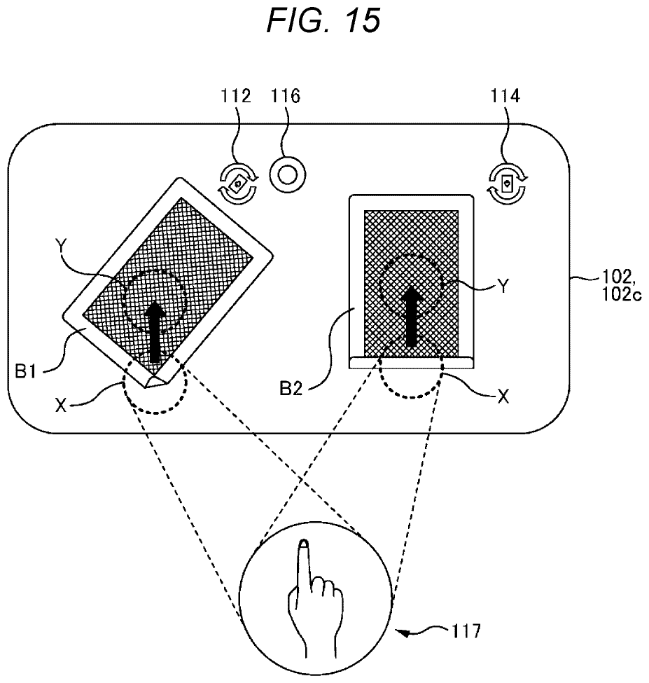

FIG. 15 illustrates a state where the squeezing motion promotion icon 117 is displayed on the user card display screen 102c. In the case of the present embodiment, if the user does nothing for, for example, five seconds after the dealer distributes cards to the user, the squeezing motion promoter 327 displays the squeezing motion promotion icon 117. This mode can naturally promote the squeezing motion for a user who is unfamiliar with the operation of the card game apparatus 100 and allows the user to enjoy the game.

Note that, after the user performs the squeezing motion once, the squeezing motion promoter 327 may not display the squeezing motion promotion icon 117 even if no operation is performed for the predetermined period of time or longer thereafter. This mode can avoid providing useless information to a user who knows how to operate the card game apparatus 100 and allows the user to enjoy the game with concentration.

When all the cards are turned face up, the win and loss processor 306 determines the winner between the player and the banker according to the rules of baccarat, and, if the side on which the user side bets wins, performs dividend payment processing.

The data storage 310 is provided in the storage device 204. When the CPU 202 performs processing for implementing each of the above-described functional units, the data storage 310 is referred to, or data is written and updated. In the data storage 310, display position data 311, card image data 312, card shape data 313, bet data 314, distributed card data 315, card rotation icon data 316, squeezing motion promotion icon data 317, and the rotation orientation setting data 318 are stored. Among these, the display position data 311, the card image data 312, the card shape data 313, and the rotation orientation setting data 318 are pre-set fixed data, and the bet data 314, the distributed card data 315, the card rotation icon data 316, and the squeezing motion promotion icon data 317 are variable data changed as the game progresses.

### <<Data Configuration>>

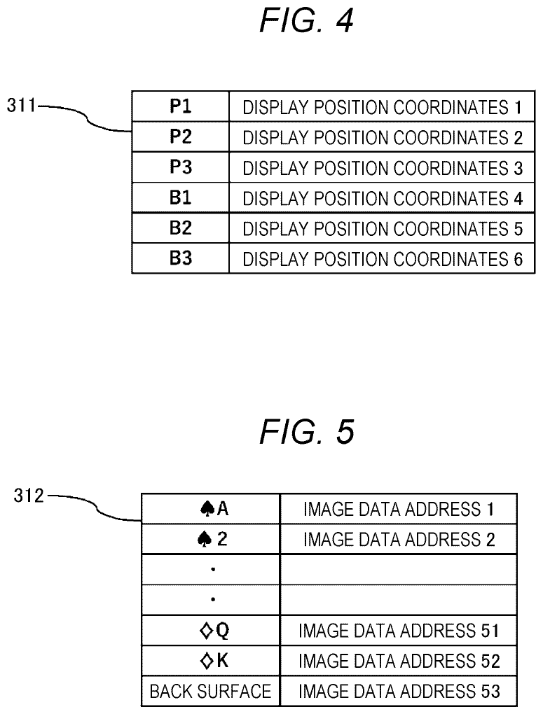

FIG. 4 is a diagram illustrating a configuration of the display position data 311.

As illustrated in FIG. 4, display position coordinates of each of three cards dealt to the player (hereinafter referred to as cards P1 to P3) and three cards dealt to the banker (hereinafter referred to as cards B1 to B3) on the display screens in the display position data 311 are preliminarily stored in the storage device 204. Note that the display position coordinates may be any that can identify a card display position, such as barycentric position coordinates of a card or position coordinates of a specific corner. If the barycentric position coordinates, which do not change the position even if the card is rotated, are used, a common card display position can be set for a plurality of rotation orientations of the card. Each card is displayed on any of a player region 101a and a banker region 101b of the dealer display device 101 and a display region of the user display device 102. If the display position coordinates in the display position data 311 indicate relative position coordinates from a specific position in each region, position coordinates common to these regions can be set.

FIG. 5 is a diagram illustrating a configuration of the card image data 312. As illustrated in FIG. 5, to the card image data 312, an address (or a file name) of image data indicating each of front surface designs of a total of 52 card types being combinations of the 4 types of suits and the 13 types of scores and a card back surface design is pre-set. The card back surface design is vertically and horizontally symmetrical, and card orientations cannot be known on the back surface. Note that the image data themselves of the cards are preliminarily stored in the storage device 204.

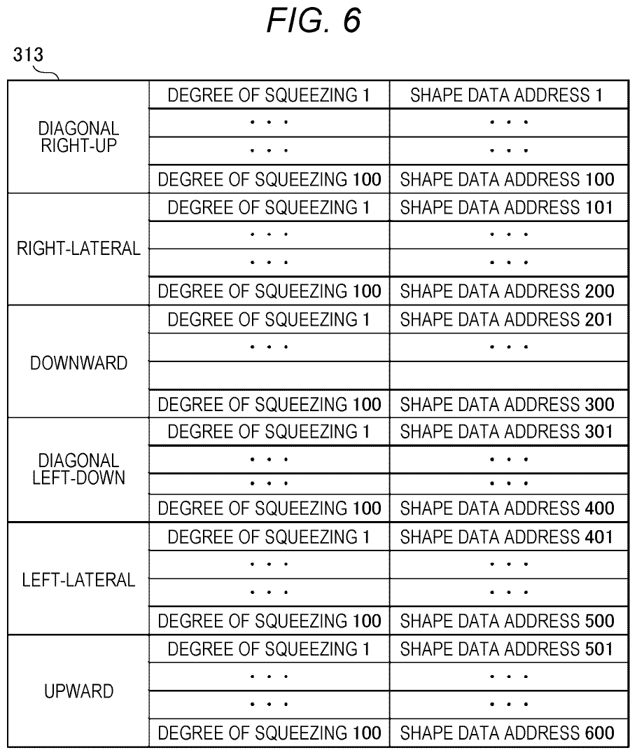

FIG. 6 is a diagram illustrating a configuration of the card shape data 313. As illustrated in FIG. 6, to the card shape data 313, data (configured by, for example, polygonal data) indicating a card outline shape in a squeezed state for each value (as described later, 0 to 100 in the present embodiment) of the degree of squeezing to a card in each of cases where the rotation orientations in displaying the card are diagonal right-up, right-lateral, downward, diagonal left-down, left-lateral, and upward is set. Note that the shape data corresponding to the degree of squeezing is stored for each rotation orientation of a card because, as described later, display of the card can be rotated diagonally right-up, right-laterally, downward, diagonally left-down, left-laterally, and upward, and, a portion and a direction in which the squeezing motion is performed to the card differ depending on the rotation orientation.

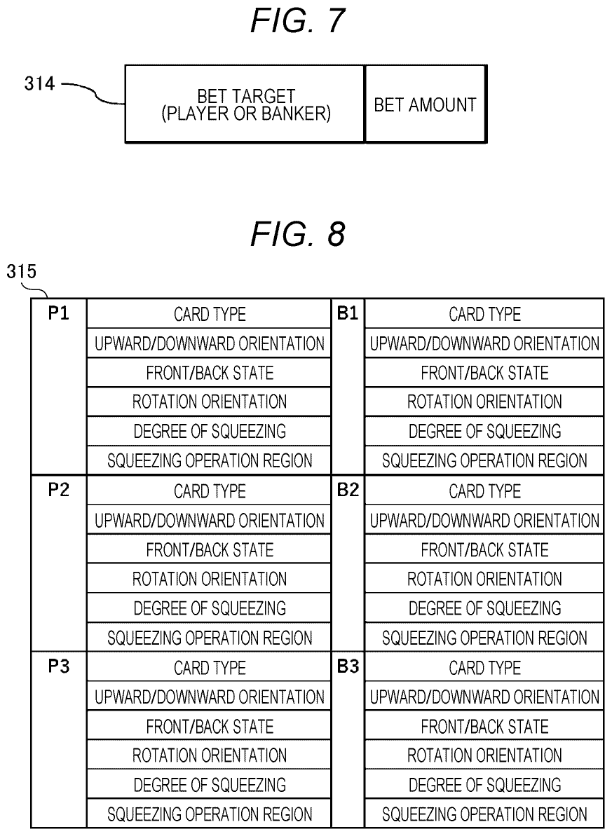

FIG. 7 is a diagram illustrating a configuration of the bet data 314. As illustrated in FIG. 7, the bet data 314 contains the bet target (the player or the banker) and the amount of the bet by the user.

FIG. 8 is a diagram illustrating a configuration of the distributed card data 315. As illustrated in FIG. 8, the distributed card data 315 contains the following items for each of the cards P1 to P3 dealt to the player and the cards B1 to B3 dealt to the banker. Note that the cards P3 and B3 are handled when the third card is dealt according to the rules of baccarat, and, at the beginning of the game, the items for the cards P3 and B3 are not set (blank).

“Card type” indicates a combination of the suit (spades, clubs, diamonds, hearts) and the score (A, 2 to 10, J, Q, K), and its default value is blank.

“Upward/downward orientation” indicates whether the card is displayed in the upward orientation or the downward orientation, and its default value is “Upward” (upward orientation).

“Front/back state” indicates whether the card is displayed face up or down, and its default value is “Back” (face down).

“Rotation orientation” indicates in which rotation orientation the card is displayed. The card displayed on the user display device 102 can be rotated, for example, diagonally right-up, right-laterally, downward, diagonally left-down, left-laterally, and upward in steps on the screen on an instruction from the user. In the present embodiment, the rotation orientation is indicated in six steps, D1 to D6, and its default value is D1.

“Degree of squeezing” indicates a degree of squeezing in the squeezing motion performed by the user by swiping the card displayed on the user display device 102, for example, by using a numerical value from 0 to 100. The value “0” of “Degree of squeezing” indicates a state where no squeezing motion is performed, and the value “100” indicates a state where the maximum squeezing is performed. If the squeezing motion is further performed from the state with the value “100”, “Front/back state” of the card becomes “Front”. The default value of “Degree of squeezing” is “0” but may be a predetermined value corresponding to a slightly turned state, such as “5” or “10”. Note that the steps 0 to 100 for the degree of squeezing are merely examples, and the number of steps may be set such that changes in a card image with the squeezing motion are subtle enough to be seen continuously.

Concerning “Squeezing operation region”, for each card displayed on the user display device 102, data identifying a region where the squeezing motion can be performed is stored. Note that, in the present embodiment, the value of “Squeezing operation region” is set for each value of “Rotation orientation” of a card, which can handle cases of different regions where the squeezing motion is performed depending on the orientation of the displayed card.

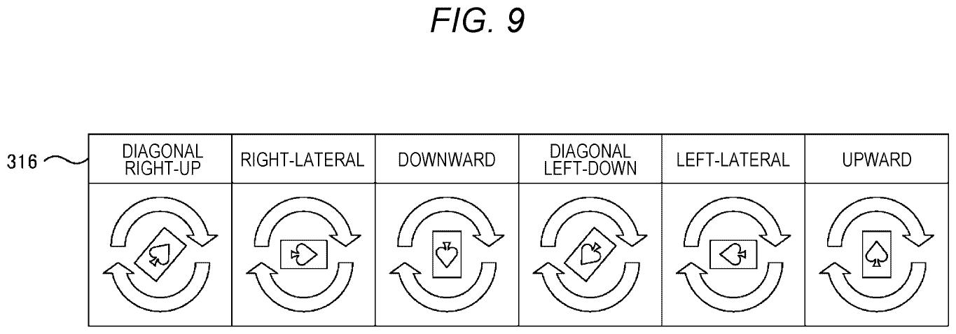

FIG. 9 is a diagram illustrating a configuration of the card rotation icon data 316. As illustrated in FIG. 9, to the card rotation icon data 316, image data indicating the design of the card rotation icons 112 and 114 is pre-set for each of the diagonal right-up orientation, the right-lateral orientation, the downward orientation, the diagonal left-down orientation, the left-lateral orientation, and the upward orientation. Note that, in the example illustrated in FIG. 9, a spade mark is displayed in the centers of the card rotation icons 112 and 114 but is unrelated to the suit of the card dealt to the user. The picture displayed in the centers of the card rotation icons 112 and 114 may be anything, for example, a picture of an animal or a character, an abstract picture, such as an arrow, a letter, such as a Chinese character or an alphabet, or the like.

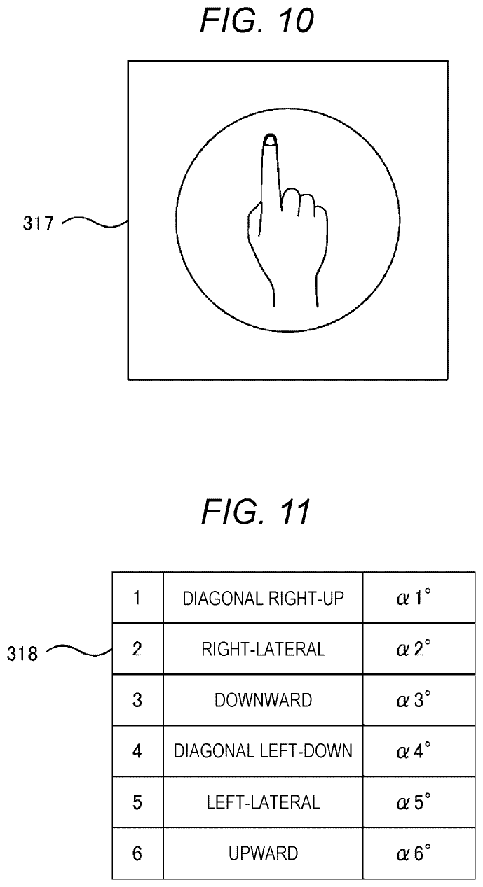

FIG. 10 is a diagram illustrating a configuration of the squeezing motion promotion icon data 317. As illustrated in FIG. 10, to the squeezing motion promotion icon data 317, image data indicating the design of the squeezing motion promotion icon 117 is pre-set.

FIG. 11 is a diagram illustrating a configuration of the rotation orientation setting data 318. The rotation orientation setting data 318 specifies the angle when the card is in each of the diagonal right-up orientation, the right-lateral orientation, the downward orientation, the diagonal left-down orientation, the left-lateral orientation, and the upward orientation, and the order of the change.

### General Overview of Processing

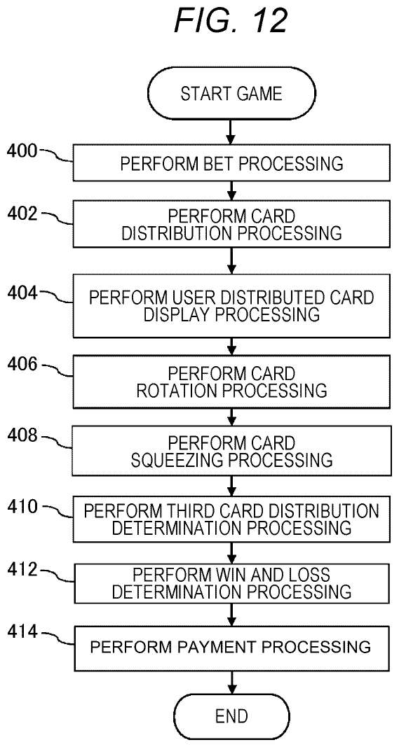

FIG. 12 is a general flow diagram illustrating an overview of a flow of processing executed from the start until the end of one round of play of a baccarat game in the card game apparatus 100.

### <<Bet Processing>>

As illustrated in FIG. 12, first, at Step 400, bet processing is performed in which the user places a bet.

To be specific, the CPU 202 reads bet screen data preliminarily stored in the storage device 204 and displays a bet screen on the user display device 102. On this bet screen, the user can select whether to bet on the banker or the player and can set a stake amount. If the user places a bet on the bet screen, the CPU 202 stores details of the bet by the user (the banker or the player on which the bet is placed and the amount of the bet) as the bet data 314 in the data storage 310.

### <<Card Distribution Processing>>

Next, at Step 402, card distribution processing is performed in which cards to be dealt to the banker and the player are determined and displayed in the player region 101a and the banker region 101b of the dealer display device 101.

To be specific, the CPU 202 randomly determines card types of the two cards P1 and P2 to be dealt to the player and the two cards B1 and B2 to be dealt to the banker while avoiding duplication. To be specific, for example, a card type 1 of the card P1 is first determined among all 52 card types by a random number, and a card type 2 of the card P2 is then determined among 51 card types excluding the determined card type 1 by a random number. Thereafter, similarly, a card type 3 of the card B1 and a card type 4 of the card B2 are sequentially determined among the card types excluding the determined card types by random numbers. Then, the determined card types 1 to 4 of the cards P1, P2, B1, and B2 are stored as the values of the item “Card type” for the respective cards P1, P2, B1, and B2 in the data storage 310.

Then, the CPU 202 displays the two cards face down in each of the player region 101a and the banker region 101b of the dealer display device 101.

### <<User Distributed Card Display Processing>>

Next, at Step 404, user distributed card display processing is performed in which the cards of the banker or the player on which the user bets are moved from the dealer display device 101 to the user display device 102 and are displayed while facing down.

FIG. 13 is a diagram illustrating a state where the user bets on the banker and the cards are moved from the banker region 101b of the dealer display device 101 to the user display device 102 and are displayed through the user distributed card display processing at Step 404.

As illustrated in FIG. 13, the display screen of the dealer display device 101 is provided with the player region 101a and the banker region 101b. In FIG. 13, on the assumption that the user has placed a bet, display of the cards in the banker region 101b on the banker side is erased, and the two cards B1 and B2 of the banker are displayed face down on the user display device 102 with only ends (in FIG. 13, corners at lower ends in the drawing) turned face up. Note that, in FIG. 13, the cards B1 and B2 are displayed in the diagonal right-up rotation orientation on the user display device 102, and how the rotation orientation of a card is determined is described later.

As illustrated in FIG. 13, the card rotation icons 112 and 114 corresponding to the two cards B1 and B2 are displayed on the user display device 102. Note that the card rotation icons 112 and 114 are displayed diagonally right-up to match the rotation orientation of the cards B1 and B2. Each time the card rotation icon 112 or 114 is touched, the corresponding card sequentially changes to be in each of the diagonal right-up orientation, the right-lateral orientation, the downward orientation, the diagonal left-down orientation, the left-lateral orientation, and the upward orientation.

FIG. 14A illustrates a state where the card B2 rotates right-laterally after the user touches the right card rotation icon 114 once. In this case, the card rotation icon 114 changes to be in the right-lateral orientation to match the rotation orientation of the card B2. If the user touches the card rotation icon 114 again, the card B2 rotates downward as illustrated in FIG. 14B. Then, the card rotation icon 114 changes to be in the downward orientation to match the rotation orientation of the card B2.

As illustrated in FIGS. 13, 14A, and 14B, a folded position of an end of a card displayed on the user display device 102 changes among a corner (the cards B1 and B2 in FIG. 13), a long side (the card B2 in FIG. 14A, and a short side (the card B2 in FIG. 14B) depending on the rotation orientation of the card, and a lower portion of the card on the screen is always displayed in a turned state.

As described later, the squeezing motion to a card is performed through swipe operation in the vicinity of the folded point in the lower portion of the card. Thus, display of the cards with their lower portions turned at the time of distributing the cards to the user display device 102 indicates, to the user, the positions where the squeezing motion is performed and also has an effect of promoting the squeezing motion.

If the user does not perform the swipe operation for the predetermined period of time, the squeezing motion promotion icon 117 (the information promoting start of the squeezing motion for the user) is displayed on the user card display screen 102c as illustrated in FIG. 15. The squeezing motion promotion icon 117 is first displayed in a first position X in the vicinity of the position where the lower portion of the card is preliminarily turned and, after a lapse of a certain period of time (for example, 0.5 seconds), smoothly moves toward a second position Y that is above the first position by a predetermined distance. Then, the squeezing motion promotion icon 117 is erased for a time, is displayed in the first position X again, and moves to the second position Y. The squeezing motion promotion icon 117 is displayed in this manner repeatedly until the user starts the squeezing motion. If the user starts the squeezing motion, the display of the squeezing motion promotion icon 117 ends. This mode can naturally promote the squeezing motion for a user who is unfamiliar with the operation of the card game apparatus 100 and allows the user to enjoy the game without difficulty.

### <<Details of User Distributed Card Display Processing>>

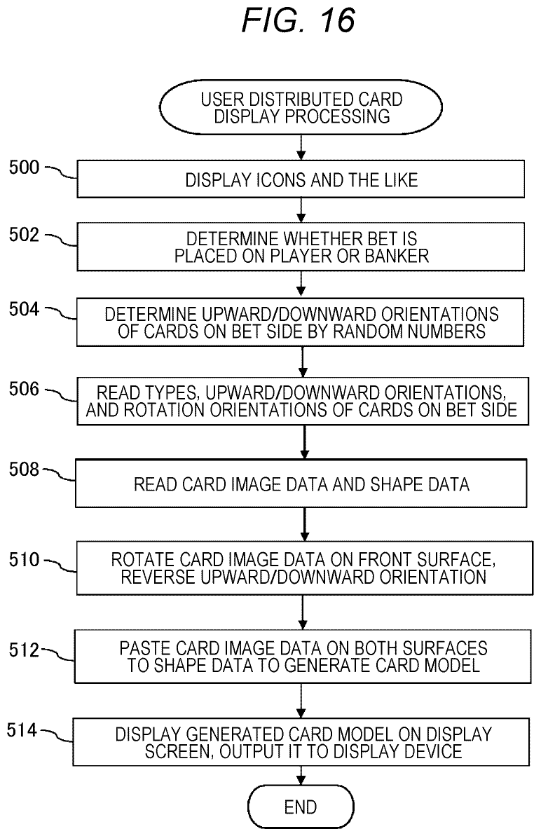

FIG. 16 is a flow diagram illustrating processing executed by the CPU 202 in the user distributed card display processing at Step 404 in more detail.

First, at Step 500, the CPU 202 displays the card rotation icons 112 and 114, an all-card disclosure icon 116, and other decorative designs in predetermined positions on the user display device 102.

Next, at Step 502, the CPU 202 refers to the bet data 314 illustrated in FIG. 7 to determine whether the user bets on the player or the banker. In the following description, assume that the user bets on the banker.

Next, at Step 504, for each of the cards B1 and B2 of the banker, on which the user bets, the upward/downward orientation (“Upward” or “Downward”) is determined by a random number and is recorded as the value of the item “Upward/downward orientation” in the distributed card data 315 illustrated in FIG. 8.

Next, at Step 506, for the cards B1 and B2 of the banker, on which the bet is placed, each value of the items “Card type”, “Upward/downward orientation”, and “Rotation orientation” is read by referring to the distributed card data 315 illustrated in FIG. 8. Note that, as described later, the rotation orientation when the first squeezing motion is performed in previous play is stored in the item “Rotation orientation”.

Next, at Step 508, by referring to the card image data 312 illustrated in FIG. 5, image data A corresponding to the value of the item “Card type” read from the distributed card data 315 and image data B corresponding to “Back surface” are read. Furthermore, by referring to the card shape data 313 illustrated in FIG. 6, shape data corresponding to the default value (for example, “0”) of “Degree of squeezing” in “Rotation orientation” read from the distributed card data 315 is read. As described above, the value “0” of “Degree of squeezing” indicates the state where no squeezing motion is performed, and, to be specific, indicates a state where an end of the card is turned slightly to the extent that the suit and the score design on the card front surface is not seen, like the cards B1 and B2 displayed on the user display device 102 in FIGS. 13, 14A, and 14B.

Next, at Step 510, the image data A is rotated in accordance with the value of “Rotation orientation”, and, if the value of “Upward/downward orientation” is “Downward”, the upward/downward orientation is reversed. Then, at Step 512, the image data A and the image data B are pasted on the front surface and the back surface of the card shape data read at Step 508 to generate a card model.

Next, at Step 514, a display screen displaying the generated card model with the card back surface visible is generated and output to the user display device 102.

Furthermore, the orientations of the card rotation icons 112 and 114 are changed to match “Rotation orientation” read from the distributed card data 315. To be specific, images corresponding to “Rotation orientation” read from the distributed card data 315 are read from the card rotation icon data 316 and displayed.

Note that, at the time of displaying the card rotation icons 112 and 114 at Step 500, the images of the card rotation icons 112 and 114 corresponding to “Rotation orientation” read from the distributed card data 315 may be displayed.

### <<Card Rotation Processing>>

After the user distributed card display processing at Step 404 in FIG. 12 is performed, card rotation processing is then performed at Step 406.

As described above, the card rotation icons 112 and 114 corresponding to the two cards B1 and B2 are displayed on the display screen of the user display device 102. Each time the card rotation icon 112 or 114 is touched, the orientation of the corresponding card B1 or B2 sequentially changes to each of the diagonal right-up orientation, the right-lateral orientation, the downward orientation, the diagonal left-down orientation, the left-lateral orientation, and the upward orientation. That is, if the right card rotation icon 114 is touched with the card diagonal right-up like the cards B1 and B2 illustrated in FIG. 13, the right card B2 rotates clockwise to a right-laterally oriented state as illustrated in FIG. 14A. If the card rotation icon 114 is touched from this state, the card is in a downward oriented state as illustrated in FIG. 14B.

In the card rotation processing, each time the card rotation icon 112 or 114 is touched, the CPU 202 updates, for the corresponding card B1 or B2, the value of the item “Rotation orientation” in the distributed card data 315 from a current value to a next value of the rotation orientation (for example, if the current value is D1, it is updated to D2). Then, the displayed card is erased, and, similar to the processing at Step 512 (FIG. 16) in the user distributed card display processing, a card model corresponding to the updated rotation orientation is generated and displayed on the user display device 102.

Then, the CPU 202 also changes the orientations of the card rotation icons 112 and 114 to match “Rotation orientation” read from the distributed card data 315.

Note that the user can perform the rotation operation on either of the two cards B1 and B2, and the rotation orientation of a card to which the squeezing motion is performed first (the rotation orientation at the time of performing the squeezing motion) is stored in the item “Rotation orientation” for all the cards P1 to P3 and B1 to B3 in the distributed card data 315.

This allows the rotation orientations of the cards displayed on the user display device 102 when a next game is played to be the same as the rotation orientation of the card to which the squeezing motion is performed first in a current game, regardless of whether a bet is placed on the player or the banker.

A portion of a card where the squeezing motion of the card is started changes depending on the card orientation among a corner, a long side, and a short side of the card, and users, especially those accustomed to playing the game, often have a preference as to which portion of a card is squeezed first. In that case, when playing the first game, the user needs to rotate the cards in a preferred orientation if the cards are not dealt in an orientation where the squeezing motion can be performed from a preferred portion.

In contrast, in the present embodiment, in the user distributed card display processing in next play, the cards can be dealt in the same rotation orientation as that of the cards set by the user in current play, that is, in an orientation matching the user's preference, so that it is unnecessary for the user to perform the rotation operation on the cards in each round of play.

### <<Card Squeezing Processing>>

After the card rotation processing at Step 406 is performed, card squeezing processing is then performed at Step 408. In the card squeezing processing, a state where a card displayed on the user display device 102 is gradually turned over in accordance with the squeezing motion by the user is displayed (that is, squeezing display). Note that, if the squeezing motion to a card is detected without the card rotation icons 112 and 114 touched, the card squeezing processing at Step 408 is performed to the card without the rotation processing at Step 406 performed.

If the user does not perform the squeezing motion for the predetermined period of time, the squeezing motion promotion icon 117 is displayed on the user card display screen 102c as illustrated in FIG. 15.

### <<Card Flip-Over Processing>>

In the card squeezing processing at Step 408, flip-over processing of turning a card face up immediately without squeezing or by interrupting the squeezing is also performed. First, the flip-over processing is described.

In the flip-over processing, each time the user presses the operation button 103, cards facing down are displayed face up one by one.

At this time, if a card of the opponent is displayed face down on the dealer card display screen 101c, the card is displayed face up. If there are a plurality of cards face down on the dealer card display screen 101c, either one of the cards selected in a predetermined order (for example, a card placed on the left side on the dealer card display screen 101c is first selected, or random selection is made) is displayed face up.

If no cards of the opponent are displayed face down on the dealer card display screen 101c, a card displayed face down on the user card display screen 102c is displayed face up. If there are a plurality of cards face down on the user card display screen 102c, similar to the case of the dealer card display screen 101c, either one of the cards selected in a predetermined order (for example, a card placed on the left side on the user card display screen 102c is first selected, or random selection is made) is displayed face up.

If the all-card disclosure icon 116 is touched, the flip-over processing is performed to all the cards displayed on the dealer card display screen 101c and the user card display screen 102c. If a condition for distributing a third card is met, the third card is also immediately distributed and displayed face up. Then, the CPU 202 jumps to win and loss determination processing at Step 412. This processing can be performed even during the card squeezing motion.

To be specific, if detecting that the operation button 103 is pressed, the CPU 202 displays cards displayed face down on the dealer card display screen 101c face up one by one, referring to “Card type” in the distributed card data 315 and the card image data 312. If no cards are displayed face down on the dealer card display screen 101c, cards displayed face down on the user card display screen 102c are displayed face up one by one, referring to “Card type” in the distributed card data 315 and the card image data 312.

If a touch to the all-card disclosure icon 116 is detected, the cards displayed on the dealer card display screen 101c and the user card display screen 102c and the third card are all displayed face up. For the card displayed face up, “Front/back state” in the distributed card data 315 is updated to “Front”.

Note that a state where a card is being turned over from the back side to the front side may be displayed with an animation as if the squeezing motion is performed to increase the sense of realism close to a game using real cards.

### <<Details of Card Squeezing Processing>>

Next, details of the card squeezing processing are described.

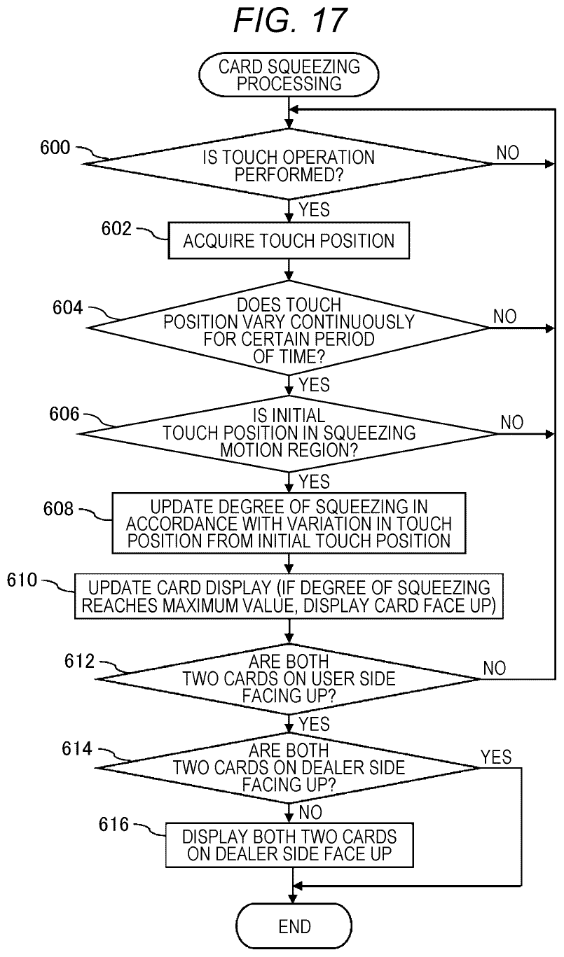

FIG. 17 is a flow diagram illustrating details of processing executed by the CPU 202 in the card squeezing processing.

First, the CPU 202 determines whether the user performs the squeezing motion to the card B1 or B2.

To be specific, the touch panel composing the user display device 102 is configured to, if detecting touch operation on the screen, supply coordinate information of the touch position to the CPU 202, and the CPU 202 determines whether touch operation is performed on the basis of whether the coordinate information of the touch position is supplied from the touch panel at Step 600.

If it is determined at Step 600 that touch operation is performed, the coordinate information of the touch position is acquired at Step 602. On the other hand, if it is determined that no touch operation is performed, the processing at Step 600 is repeated.

Next, at Step 604, it is determined whether the touch position varies continuously for a certain period of time. If it is determined that the touch position varies continuously, it is determined at Step 606 whether the position where the touch starts (touch start position) is contained in the item “Squeezing operation region” for the card B1 or B2, referring to the distributed card data 315. If the position is contained in “Squeezing operation region”, it is determined that the squeezing motion is performed to the card B1 or B2. However, if the item “Front/back state” for the card B1 or B2 indicates front, the squeezing motion is invalid because it indicates that the card facing up is swiped. If negative determination is made at Step 604 or 606, or if it is determined that the squeezing motion is invalid, the procedure returns to Step 600.

Assume that it is determined that the squeezing motion is performed to either card at Step 606 (the card to which the squeezing motion is performed is hereinafter referred to as “card of interest”). Next, at Step 608, the value of the item “Degree of squeezing” for the card of interest in the distributed card data 315 is increased or decreased in accordance with a difference between an initial touch position and a current touch position supplied from the touch panel. To be specific, if the touch position varies upward (in a squeezing direction), the value is increased by “1”. If it varies downward (in a squeezing return direction), the value is decreased by “1”. With this, if the card of interest is swiped upward, the degree of squeezing is increased as the squeezing motion progresses, and, if the swipe operation is performed downward, the degree of squeezing is decreased as the squeezing motion is withdrawn. Note that the increase and decrease range of “Degree of squeezing” may be greater as the speed of the squeezing motion (swipe speed) is faster, in accordance with the speed.

Then, at Step 610, the displayed card of interest is erased, and similar to the processing at Step 510 (FIG. 16) in the user distributed card display processing, a card model corresponding to “Degree of squeezing”, “Rotation orientation”, and “Upward/downward orientation” after the update is generated and displayed on the user display device 102. This allows display of the card of interest to be updated in accordance with the squeezing motion and enables a state similar to squeezing of a real card to be reproduced with graphics, which can provide a true-to-life feeling similar to play with real cards to the user.

Note that, in the card squeezing processing, when the cards are displayed, indices (suits and scores) drawn in the vicinities of the corners on the card front surfaces are not displayed as illustrated in FIG. 18B. This prevents the card type from being known immediately after the squeezing motion is started.

If the value of “Degree of squeezing” reaches a maximum value (100 in the present embodiment) at Step 610, the card of interest is displayed face up, and the value of the item “Front/back state” in the distributed card data 315 is updated to front. This ends the squeezing motion to the card of interest.

Note that the user can perform a flick motion at any timing, such as during, at the end of, or before the start of the squeezing motion. If the flick motion is performed, the card is returned to the dealer and displayed face up on the dealer card display screen 101c.

At Step 612 following Step 610, “Front/back state” in the distributed card data is determined for the cards B1 and B2 on the user side. If “Front/back state” for one or both of the cards B1 and B2 on the user side is “Back” as a result, the procedure returns to Step 600 to continue the card squeezing processing.

On the other hand, if “Front/back state” for both the two cards is “Front” at Step 612, it is determined whether “Front/back state” for both the cards P1 and P2 on the dealer side is “Front” at Step 614. If “Front/back state” for one or both is “Back”, the card or cards are displayed face up at Step 616, “Front/back state” in the distributed card data 315 is updated to “Front”, and the card squeezing processing ends. If “Front/back state” for both the cards P1 and P2 is “Front” at Step 614, the card squeezing processing ends as is.

After the card squeezing processing illustrated in FIG. 17 ends, the procedure then proceeds to Step 410 in FIG. 12.

At Step 410, on the basis of the scores of the cards P1 and P2 on the dealer side and the cards B1 and B2 on the user side, which have been turned face up, it is determined whether a third card is dealt to each of the banker and the player according to the rules of baccarat. If it is determined that the third card is dealt, a card to be dealt is determined and displayed face down, and the card squeezing processing is performed, in the same manner as at Steps 402 to 408.

Next, at Step 412, the winner is determined according to the rules of baccarat on the basis of the scores of the two or three cards dealt to each of the banker and the player and turned face up.

Finally, at Step 414, if the side on which the user bets wins between the banker and the player, the payment processing of a dividend being the product of the amount of the bet multiplied by a predetermined multiplier is performed, and the current game ends.

### Other Effects of the Present Embodiment

(1) The squeezing motion to a card displayed on the user display device 102 includes the diagonal squeezing, the vertical squeezing, and the horizontal squeezing, and the start position of the squeezing motion is a lower portion of the card in any squeezing method. In the present embodiment, when a distributed card is displayed on the user display device 102, a lower portion of the card on the screen is displayed while being turned to the extent that the design on the card front surface is not seen. That is, a portion where the squeezing motion should be started is displayed while being turned, which can indicate, to the user, the position where the squeezing motion is performed and promote the squeezing motion.

Note that, if the start position of the squeezing motion is not a lower portion of a card because of the type of card game, custom, or the like, display of a portion, corresponding to the start position, of the card turned face up can obtain an effect similar to that of the present embodiment.

(2) The user may prefer any squeezing method among the diagonal squeezing, the vertical squeezing, and the horizontal squeezing as the squeezing motion to a card, and which squeezing method can be performed is determined by the rotation orientation of a distributed card. In the present embodiment, the card rotation orientation when the user first performs the squeezing motion is stored, and, in the next play, a card is displayed in the stored card rotation orientation on the user display device 102. Thus, if the user selects an orientation in which the preferred squeezing method can be performed in the first play when playing a plurality of games successively, a card is dealt in the rotation orientation matching the squeezing method preferred by the user from the next play onward. With this, the user can perform the squeezing motion in the preferred squeezing method without performing a card rotation motion in each round of play and can concentrate on the squeezing motion, which is the most exciting part of the game.

### Modifications

(1) The above-described embodiment has described a case where the card game apparatus 100 is an apparatus for playing baccarat using playing cards; however, no such limitation is intended. The present invention can be applied to a card game that involves a squeezing motion of gradually turning over, from an end, a card distributed face down such that the back surface can be seen and in which the winner is determined in accordance with the score or other designs on the card front surface. Furthermore, cards used are not limited to playing cards, and application to a card game using other cards is possible.

(2) In the above-described embodiment, on the assumption that rectangular playing cards are used, the upward/downward orientation as the card orientation in the present invention is randomly determined when the card is distributed. However, regarding the card orientation, in the case of a game using, for example, square cards, any of the four orientations, upward, downward, left, and right, may be randomly determined. In the case of using, for example, hexagonal cards, any of the six orientations may be randomly determined. In the case of using circular cards, any orientation may be randomly determined. In short, if there are a plurality of orientations that cannot be distinguished just by looking at the back surface of a card, which orientation the card is distributed in may be randomly determined as the card orientation.

(3) In the above-described embodiment, the display device provided to the card game apparatus 100 is separated into the dealer display device 101 and the user display device 102; however, no such limitation is intended. A display device may be common to the dealer side and the user side, and the dealer card display screen 101c and the user card display screen 102c may be displayed on a screen of the display device.

(4) The above-described embodiment has described a case where the card game apparatus 100 is a stand-alone apparatus having the processing function necessary for the game and including the display devices 101 and 102 (touch panels also serving as input devices); however, no such limitation is intended. The card game apparatus of the present invention may be configured, for example, as a server connected to a network, such as the Internet, the user may access the server from a computer terminal, the server may receive various operations on the user terminal via the network, and a display screen for the user may be transmitted from the server to the user terminal via the network.

Examples of the combinations of disclosed technical characteristics are described below.

(1) A card game apparatus for making progress of a card game in which a card with a design depicted on a front surface and indicating a card type is dealt face down from a dealer to a user and, when turning the dealt card face up, the user can perform a squeezing motion of turning from an end of the card, the card game apparatus including:
a storage device; and
a CPU connected to the storage device, in which
the CPU executes
   displaying the card dealt to the user face down on a user card display screen on which a state at a side of the user is simulated,
   receiving a rotation instruction for the card through operation input to a predetermined input region disposed on the user card display screen,
   rotating the card by changing an orientation of the card in steps each time the rotation instruction is received, and
   displaying an icon promoting input of the rotation instruction and having a predetermined shape in the predetermined input region while rotating the icon to match a current orientation of the card.

(2) The card game apparatus according to (1), in which
the storage device stores setting information specifying each orientation, changed in steps, of the card and an order of the change, and
the CPU rotates the card by sequentially changing the orientation of the card to each orientation specified in the setting information each time the rotation instruction is received.

(3) The card game apparatus according to (2), in which
the card has a rectangular shape,
the setting information specifies a diagonal right-up orientation, a right-lateral orientation, a downward orientation, a diagonal left-down orientation, a left-lateral orientation, and an upward orientation as the orientation of the card, and
the CPU rotates the card so that an orientation from one short side of the card toward another short side is changed sequentially to the diagonal right-up orientation, the right-lateral orientation, the downward orientation, the diagonal left-down orientation, the left-lateral orientation, and the upward orientation each time the rotation instruction is received.

(4) The card game apparatus according to any one of (1) to (3), in which the CPU executes
receiving a flick instruction to return the card distributed to the user to the dealer, and
in response to the flick instruction, moving the card displayed on the user card display screen to a dealer card display screen on which a state at a side of the dealer is simulated and displaying the card face up.

(5) The card game apparatus according to any one of (1) to (4), in which the CPU executes
receiving the squeezing motion by the user, and
displaying the card displayed face down on the user card display screen in such a manner that the card is turned over gradually in accordance with the squeezing motion.

(6) The card game apparatus according to (5), in which the CPU executes
receiving a flip-over instruction to reverse, face up, the card displayed face down without performing or by interrupting the squeezing motion, and
reversing the card face up in response to the flip-over instruction.

(7) The card game apparatus according to (6), in which
the card game is baccarat, and
the CPU executes
   displaying a card distributed to an opponent on which the user does not bet, on a dealer card display screen on which a state at a side of the dealer is simulated, and
   upon reception of the flip-over instruction, with a card of the opponent being displayed face down on the dealer card display screen, reversing the card face up, and, with no card of the opponent being displayed face down on the dealer card display screen, reversing, face up, the card displayed face down on the user card display screen.

(8) The card game apparatus according to any one of (5) to (7), in which the CPU executes displaying information promoting start of the squeezing motion on the user card display screen in response to the user not starting the squeezing motion after a lapse of a predetermined period of time after the dealer distributes the card to the user.

1. A method comprising:
generating an image of a card having a face surface with a pattern indicating a card type;
displaying, on a user card display screen that simulates the user's hand, the card oriented with the face surface down;
displaying, in a predetermined input region provided on the user card display screen, an icon of a predetermined shape that prompts rotation instruction input;
accepting, via an operation input to the predetermined input region, one or more rotation instructions for the card;
rotating the card by changing, in a stepwise manner, an orientation of the card within a plane of the card for each rotation instruction that is accepted; and
rotating the icon to match the current orientation of the card for each rotation instruction that is accepted.

2. The method according to claim 1, further comprising:
storing, with a storage device, setting information that includes a plurality of predefined card orientations and an orientation order;
wherein the rotating the card comprises sequentially changing, in the stepwise manner, the orientation of the card to one or more predefined card orientations among the plurality of predefined card orientations in the orientation order for each rotation instruction that is accepted.

3. The method according to claim 2, wherein
the card has a rectangular shape with a first side perpendicular to a second side that is longer than the first side;
the plurality of predefined card orientations consists of an upper-right orientation, a rightward orientation, a downward orientation, a lower-left orientation, a leftward orientation, and an upward orientation; and
the rotating the card includes rotating the card so that a direction perpendicular to the first side sequentially changes to one of an upper-right direction, a rightward direction, a downward direction, a lower-left direction, a leftward direction, and an upward direction each time the rotation instruction is accepted.

4. The method according to claim 1, further comprising:
accepting a flick instruction to return the card displayed on the user card display screen; and
moving, in response to the flick instruction, the card displayed on the user card display screen to a dealer card display screen that simulates a dealer's hand, the card oriented with the face surface up on the dealer card display screen.

5. The method according to claim 1, further comprising:
accepting the squeeze operation by the user; and
displaying the card on the user card display screen as being peeled back such that an area of the face surface in accordance with the squeeze operation is displayed from an edge of the card toward a squeeze direction until a line, in the plane of the card, perpendicular to the squeeze direction.

6. The method according to claim 5, further comprising:
accepting a flip-over instruction; and
displaying, in response to the flip-over instruction, the card on the user card display screen oriented with the face surface up either without performing the squeeze operation or by interrupting the squeeze operation.

7. The method according to claim 6, further comprising:
displaying, on the dealer card display screen, one or more cards dealt to another side that the user did not bet on;
displaying, oriented with the face surface up, a card among the one or more cards dealt to the other side on the dealer card display screen in response to accepting the flip-over instruction while the card is oriented with the face surface down; and
displaying, oriented with the face surface up, the card displayed on the user card display screen in response to accepting the flip-over instruction while no card among the one or more cards dealt to the other side on the dealer card display screen is oriented with the face surface down;
wherein the card game is baccarat.

8. The method according to claim 5, further comprising:
displaying on the user card display screen information prompting the start of the squeeze operation in response to expiration of a predetermined time period since the card was displayed on the user card display during which no squeeze operation has been input.

9. An apparatus comprising:
a controller comprising circuitry configured to perform operations comprising:
generating an image of a card having a face surface with a pattern indicating a card type;
displaying, on a user card display screen that simulates the user's hand, the card oriented with the face surface down;
displaying, in a predetermined input region provided on the user card display screen, an icon of a predetermined shape that prompts rotation instruction input;
accepting, via an operation input to the predetermined input region, one or more rotation instructions for the card;
rotating the card by changing, in a stepwise manner, an orientation of the card within a plane of the card for each rotation instruction that is accepted; and
rotating the icon to match the current orientation of the card for each rotation instruction that is accepted.

10. The apparatus according to claim 9, wherein the operations further comprise:
storing, with a storage device, setting information that includes a plurality of predefined card orientations and an orientation order;
wherein the rotating the card comprises sequentially changing, in the stepwise manner, the orientation of the card to one or more predefined card orientations among the plurality of predefined card orientations in the orientation order for each rotation instruction that is accepted.

11. The apparatus according to claim 10, wherein the card has a rectangular shape with a first side perpendicular to a second side that is longer than the first side;
the plurality of predefined card orientations consists of an upper-right orientation, a rightward orientation, a downward orientation, a lower-left orientation, a leftward orientation, and an upward orientation; and
the rotating the card includes rotating the card so that a direction perpendicular to the first side sequentially changes to one of an upper-right direction, a rightward direction, a downward direction, a lower-left direction, a leftward direction, and an upward direction each time the rotation instruction is accepted.

12. The apparatus according to claim 9, wherein the operations further comprise:
accepting a flick instruction to return the card displayed on the user card display screen; and
moving, in response to the flick instruction, the card displayed on the user card display screen to a dealer card display screen that simulates a dealer's hand, the card oriented with the face surface up on the dealer card display screen.

13. The apparatus according to claim 9, wherein the operations further comprise:
accepting the squeeze operation by the user; and
displaying the card on the user card display screen as being peeled back such that an area of the face surface in accordance with the squeeze operation is displayed from an edge of the card toward a squeeze direction until a line, in the plane of the card, perpendicular to the squeeze direction.

14. The apparatus according to claim 13, wherein the operations further comprise:
accepting a flip-over instruction; and
displaying, in response to the flip-over instruction, the card on the user card display screen oriented with the face surface up either without performing the squeeze operation or by interrupting the squeeze operation.

15. The apparatus according to claim 14, wherein the operations further comprise:
displaying, on the dealer card display screen, one or more cards dealt to another side that the user did not bet on;
displaying, oriented with the face surface up, a card among the one or more cards dealt to the other side on the dealer card display screen in response to accepting the flip-over instruction while the card is oriented with the face surface down; and
displaying, oriented with the face surface up, the card displayed on the user card display screen in response to accepting the flip-over instruction while no card among the one or more cards dealt to the other side on the dealer card display screen is oriented with the face surface down;
wherein the card game is baccarat.

16. The apparatus according to claim 13, wherein the operations further comprise:
displaying on the user card display screen information prompting the start of the squeeze operation in response to expiration of a predetermined time period since the card was displayed on the user card display during which no squeeze operation has been input.

17. A non-transitory computer-readable medium having instructions stored thereon that, when executed by one or more processors, perform operations comprising:
generating an image of a card having a face surface with a pattern indicating a card type;
displaying, on a user card display screen that simulates the user's hand, the card oriented with the face surface down;
displaying, in a predetermined input region provided on the user card display screen, an icon of a predetermined shape that prompts rotation instruction input;
accepting, via an operation input to the predetermined input region, one or more rotation instructions for the card;
rotating the card by changing, in a stepwise manner, an orientation of the card within a plane of the card for each rotation instruction that is accepted; and
rotating the icon to match the current orientation of the card for each rotation instruction that is accepted.

18. The computer-readable medium according to claim 17, wherein the operations further comprise:
storing, with a storage device, setting information that includes a plurality of predefined card orientations and an orientation order;
wherein the rotating the card comprises sequentially changing, in the stepwise manner, the orientation of the card to one or more predefined card orientations among the plurality of predefined card orientations in the orientation order for each rotation instruction that is accepted.

19. The computer-readable medium according to claim 18, wherein
the card has a rectangular shape with a first side perpendicular to a second side that is longer than the first side;
the plurality of predefined card orientations consists of an upper-right orientation, a rightward orientation, a downward orientation, a lower-left orientation, a leftward orientation, and an upward orientation; and
the rotating the card includes rotating the card so that a direction perpendicular to the first side sequentially changes to one of an upper-right direction, a rightward direction, a downward direction, a lower-left direction, a leftward direction, and an upward direction each time the rotation instruction is accepted.

20. The computer-readable medium according to claim 17, wherein the operations further comprise:
accepting a flick instruction to return the card displayed on the user card display screen; and
moving, in response to the flick instruction, the card displayed on the user card display screen to a dealer card display screen that simulates a dealer's hand, the card oriented with the face surface up on the dealer card display screen.
